(19) United States
(12) Patent Application Publication
(10) Pub. No.: US 2012/0191529 A1
(43) Pub. Date: Jul. 26, 2012

(54) METHODS AND SYSTEMS FOR A PREDICTIVE ADVERTISING TOOL

(75) Inventors: Scott Lewis, San Diego, CA (US); Sanjana Tandon, San Francisco, CA (US); Boris A. Fedorov, San Francisco, CA (US)

(73) Assignee: INTUIT INC., Mountain View, CA (US)

(21) Appl. No.: 13/014,447

(22) Filed: Jan. 26, 2011

(51) Int. Cl. G06Q 30/00

(52) U.S. Cl. 705/14.41

(57) ABSTRACT

Systems, methods and articles of manufacture for a computerized advertising analysis tool for identifying and/or predicting the effect of future external events on the viewership and effectiveness of an advertising campaign. The system access and analyzes data regarding past events and viewership data to determine the past effect on viewership. The system then accesses analyzes future events to predict and estimate the effect of the future events on the advertising campaign based on the analysis of past events and viewership data. An advertiser may then use this information to evaluate the advertising campaign, allowing the advertiser to modify or negotiate the proper pricing for the advertising campaign.

### BACKGROUND

The invention relates to marketing and advertising; and more particularly, to new methods and systems for a predictive advertising tool.

Advertisers spend tremendous amounts of money annually to reach consumers through advertising via the numerous available media outlets, such as television, radio, websites on the internet, among many others. When determining the advertising parameters for an advertising campaign, such as timing, site placement, and cost, an advertiser generally relies on the information available from the advertising publisher (which includes any advertising outlet, such as TV or radio broadcast, website, billboard, poster, etc.) or an advertising agency hired by the advertiser. The publisher may provide an estimate of the viewership (including viewership demographics) of advertisements based on advertising schedules, ratings and statistics from ratings and tracking services, such as Nielson ratings for television, and Quantcast™ for websites.

However, there are many other factors that may impact the success of an advertising campaign, such as outside influences that may affect the traffic and/or receptiveness to the advertising campaign. For instance, there may be a major event, such as a sporting event, concert, or convention, or a local event, that will have a significant effect on the viewership of the advertisement that is not considered in the publisher estimates. While the advertiser can attempt to search for events that may impact the proposed advertising campaign, this is a difficult and time consuming process. Moreover, missing just one crucial event can cause serious negative consequences to the advertiser, such as placing the advertisement at the wrong time and/or outlet, overpaying for the advertising, and obtaining less effectiveness from the advertising.

### SUMMARY

The present invention is directed to methods, systems, and articles of manufacture for a predictive advertising tool. The systems, methods and articles are configured to identify events that will affect an advertising campaign and/or to predict an effect on an advertising campaign by such events which are scheduled at the same time or about the same time as the scheduled time period of the advertisement or campaign. As used herein, the term “advertising campaign” means the dissemination of one or more advertisements, and does not require multiple advertisements or a series of advertisements. An advertising campaign that is not limited to just one advertisement, but a series of advertisements, shall be referred to as an “advertising campaign comprising a plurality of advertisements” or something similar indicating more than one advertisement. In this way, an advertiser can better evaluate the value of the advertisement or advertising campaign, instead of simply relying on minimal viewership averages for advertising time slots provided by advertising publishers and advertising agencies. The methods and systems can take into account a full spectrum of externalities that may have an effect on the success of an advertisement or a marketing campaign, such as the viewership and/or viewership demographics. As described above, an advertiser currently does not have a resource for forecasting the success of an advertising campaign because the advertiser does not know what external events might influence viewership and/or receptiveness to the advertisements.

Accordingly, one embodiment of the present invention is directed to a method for identifying events that may have an effect on an advertising campaign scheduled for a selected time period. The method comprises a step of accessing, by an advertising analysis system, past event data regarding a plurality of past events, each past event occurring during a respective past event time period. The advertising analysis system is typically a computerized system including hardware and software configured to implement the method, as described in more detail below.

The advertising analysis system may access the past event data by any suitable means, such as a database in operable communication with the system, and/or through one or more application programming interfaces (APIs) that gather, track, store and distribute event data from numerous media outlets, such as Ticketmaster, CitySearch, and the like. The event data may include the type of event, performer(s), event time and duration, location or outlet, attendance, etc.

The advertising analysis system also accesses viewership data regarding media viewership during the past event time periods of the past events. For instance, the viewership data may include the viewership data for the particular advertising site being considered for the advertising campaign, such as a particular television station or website. The system may access the viewership data from one or more available APIs or other suitable means. The viewership data may include data reflecting the actual viewership (including hits or traffic to a website) during the past event time periods for the past events.

The advertising analysis system then correlates the past events to the viewership data. In other words, the system analyzes the event data and the viewership data in order to make an association between a past event and the viewership of a particular media outlet. For instance, the system may correlate that a rock concert in Los Angeles impacted the viewership of the CBS affiliate in Los Angeles during the period of time of the concert, because the concert and the CBS affiliate are geographically located in the same vicinity. The correlation may also take into account many other factors, such as a statistical analysis of other similar events and viewership data to determine a correlation between an event and viewership data.

Then, the advertising analysis system determines whether the correlated past events had an effect on media viewership based on the step of correlating past events to the viewership data. This step may involve determining, or estimating, a past effect on media viewership based on the step of correlating past events to the viewership data. Moreover, the system may perform this step simultaneously with the step of correlating the past events to the viewership data. Continuing the example above, the system may determine that the rock concert had a significant effect on the viewership of the CBS affiliate because it diverted a certain number of viewers, or a threshold percentage of viewers, from the CBS affiliate, that would constitute a statistically significant effect on media viewership.

The advertising analysis system also accesses future event data regarding future events scheduled during, or around, the selected time period. This may be accomplished by any suitable method, for example, by using an API configured for providing data on future events.

Based at least in part upon the determining step, the advertising analysis system identifies one or more future events that are likely to have an effect on the effectiveness of the advertising campaign. Continuing the example above, the system may determine that there is a rock concert similar to the past rock concert scheduled during the selected time period of the advertising campaign. The system can then identify the future rock concert as having a likelihood of having a similar effect on the viewership of the CBS affiliate during the selected time period of the advertising campaign.

An advertiser can then use the information for the identified future events to evaluate the advertising campaign. For instance, the advertiser can decide to reschedule the advertising campaign to avoid disruptive future events, or to coincide with future events having a positive effect on the advertising campaign (e.g. an event that will increase viewership by the desired demographic). The advertiser can use the information for the identified future events to negotiate the price from the publisher for distributing the advertising campaign.

Another embodiment of the present invention is directed to a method for predicting an effect on an advertising campaign scheduled for a selected time period. This method is very similar to the method for identifying future events having an effect on an advertising campaign, except that this method also provides an actual prediction of the effect. Like the method above, the method comprises a step of accessing, by an advertising analysis system, past event data regarding a plurality of past events, each past event occurring during a respective past event time period. As in the method above, the predictive system also: accesses viewership data regarding media viewership during the past event time periods of the past events; determines a past effect on media viewership based on the step of correlating past events to the viewership data; and correlates the past events to the viewership data.

Then, instead of determining whether the past events had an effect on media viewership based on the step of correlating past events to the viewership data, as in the method above, the advertising analysis system determines the magnitude of the actual past effect on media viewership based on the step of correlating past events to the viewership data. Therefore, the method determines an actual magnitude of the past effect on media viewership. Continuing the example above, the system may determine that the rock concert had a significant effect caused a decrease in the viewership of the CBS affiliate in Los Angeles by 600,000 viewers. As described above, for example, the system may determine that the rock concert caused a decrease in the viewership of the CBS affiliate in Los Angeles by 600,000 viewers.

Next, the advertising analysis system, predicts a future effect on viewership of the advertising campaign by future events scheduled for the scheduled time period based, at least in part, upon the determined past effect. The advertising analysis system may access data regarding future events scheduled, such as by using an API configured for providing data on future events. Carrying on the above example, the system may determine that there is a rock concert similar to the past rock concert scheduled during the scheduled time period of the advertising campaign. The system can then predict a similar decrease in the viewership of the CBS affiliate, assuming that one of the potential advertising sites for the advertising campaign is the CBS affiliate, or a similar site.

This method is not limited to predicting decreases in viewership, but may also predict situations having an effect that increases viewership, such as a very popular event being aired on the potential advertising site at or near the scheduled time period of the advertising campaign.

Again, an advertiser can then use the information for the predicted effect on the advertising campaign to evaluate the advertising campaign. Similar to the method above, the advertiser can assess the scheduling of the campaign to avoid disruptive future events, or to coincide with future events having a positive effect on the advertising campaign. The advertiser can also use the predicted effect to evaluate the competitive pricing structure for the advertising campaign and to help negotiate the price from the publisher for distributing the advertising campaign.

Still another embodiment of the present invention is directed to an advertising analysis system for implementing the above-described methods for a predictive advertising tool. As described above, the system comprises one or more computer servers, and/or other computers which are configured to access past event data, viewership data, and future event data. Thus, the system may be in communication with other databases and servers through one or more networks, including any private network or the internet, in order to communicate and access data. The system may also include a website server hosting a web application for accessing the system over the internet, or it may simply be networked to a website server for accessing the system over the internet.

The computer(s) of the system are configured and programmed to perform the steps of at least one of the method embodiments of the predictive advertising tool of the present invention, including, for example, a method comprising the steps of: (a) accessing past event data regarding a plurality of past events occurring during respective past event time periods; (b) accessing viewership data regarding media viewership during the past event time periods of said past events; (c) correlating the past events to the viewership data; (d) determining whether the correlated past events had a significant effect on media viewership based on the step of correlating past events to the viewership data; and (e) identifying one or more future events that are likely to have an effect on the effectiveness of the advertising campaign, based at least in part upon the determining step. As another example, the computer(s) of the system are configured and programmed to perform a method comprising the steps of: (a) accessing past event data regarding a plurality of past events occurring during respective past event time periods; (b) accessing viewership data regarding media viewership during the past event time periods of said past events; (c) correlating the past events to the viewership data; (d) determining a past effect on media viewership based on said step of correlating said past events to said viewership data; and (e) predicting a future effect on viewership of the advertising campaign by future events scheduled for said scheduled time period based, at least in part, upon said determined past effect.

Another embodiment of the present invention is directed to an article of manufacture comprising a computer program carrier readable by a computer and embodying instructions executable by the computer to program a computer system to perform the steps of at least one of the method embodiments for the predictive advertising tool of the present invention, including, for example: (a) accessing past event data regarding a plurality of past events occurring during respective past event time periods; (b) accessing viewership data regarding media viewership during the past event time periods of said past events; (c) correlating the past events to the viewership data; (d) determining whether the correlated past events had a significant effect on media viewership based on the step of correlating past events to the viewership data; and (e) identifying one or more future events that are likely to have an effect on the effectiveness of the advertising campaign, based at least in part upon the determining step. As still another example, article of manufacture may comprise a computer program carrier readable by a computer and embodying instructions executable by the computer to program a computer system to perform the steps of: (a) accessing past event data regarding a plurality of past events occurring during respective past event time periods; (b) accessing viewership data regarding media viewership during the past event time periods of said past events; (c) correlating the past events to the viewership data; (d) determining a past effect on media viewership based on said step of correlating said past events to said viewership data; and (e) predicting a future effect on viewership of the advertising campaign by future events scheduled for said scheduled time period based, at least in part, upon said determined past effect.

### BRIEF DESCRIPTION OF THE DRAWINGS

The foregoing and other aspects of embodiments are described in further detail with reference to the accompanying drawings, wherein like reference numerals refer to like elements and the description for like elements shall be applicable for all described embodiments wherever relevant:

FIG. 1 is a flow chart of a method of identifying events that may have an effect on an advertising campaign according to one embodiment of the present invention;

FIG. 2 is a flow chart of a method for predicting an effect of an event on an advertising according to another embodiment of the present invention;

FIG. 3 illustrates an exemplary system for providing an advertising analysis tool for implementing the methods of the present invention, according to another embodiment of the present invention.

### DETAILED DESCRIPTION OF ILLUSTRATED EMBODIMENTS

Embodiments of the present invention are directed to methods, systems and articles of manufacture for providing a computer-implemented advertising analysis tool which can identify, and/or predict an effect of, events that may have an effect on the advertising campaign. The information provided by the advertising analysis tool can then be used by advertisers to evaluate and assess the advertising campaign, allowing the advertiser to make informed decisions regarding the advertising campaign, such as when to schedule the advertising campaign, what sites to use to place the advertising campaign, how much to pay the sites for placing the advertising, among other advertising parameters.

When planning an advertising campaign, an advertiser considers various advertising parameters designed to maximize the impact of the advertising for the amount spent. One major advertising parameter is the budget, how much to spend on the campaign. Another parameter will usually be the scheduled time period for the advertising campaign. For example, if the advertiser is launching a new product, the advertiser will want to schedule the advertising campaign to coincide with the launch, or possibly start shortly before the launch in order to build demand. Another parameter may be the target demographics for the advertising campaign, such as the age group, sex, marital status, education, geographic location, and occupation. Other parameters may include even more specific information, such as selected sites for advertising campaign, number of advertisements for the advertisement campaign, a target level of viewership, as examples.

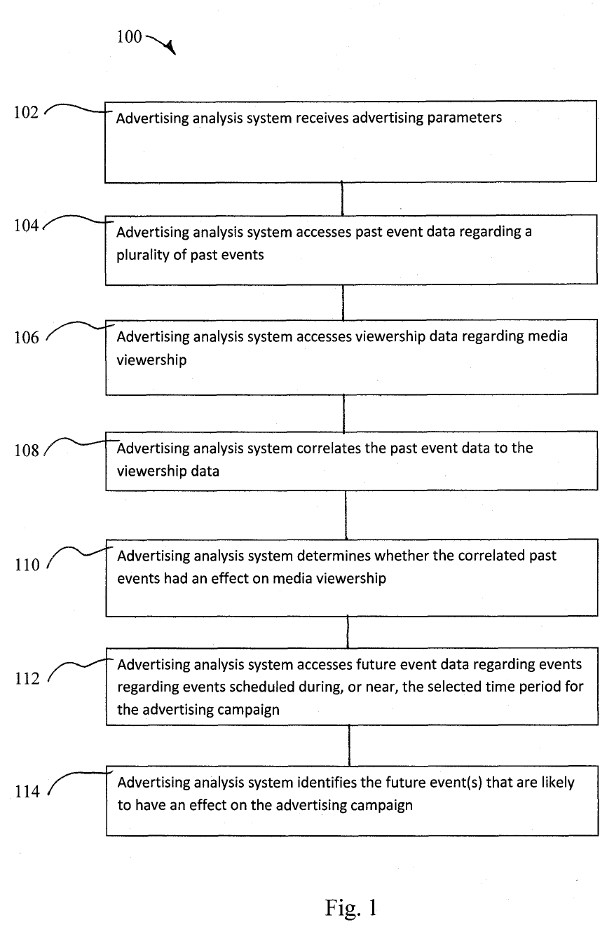

That said, referring to FIG. 1, in one embodiment, a method 100 is shown for identifying future events that may have an effect on an advertising campaign, such as an external event that may have a disruptive or positive effect on the impact of the advertising campaign. For instance, the event may affect the size of the viewership and/or demographics of the viewership of the advertising campaign. As described in more detail below, the method 100 will typically be implemented on a computerized advertising analysis system comprising one or more computers, computer servers, website servers, and/or other computers networked together, or alternatively may be a single computer, such as a user's home or office computer. While the exemplary embodiments described herein are directed to a networked server system provided by an advertising analysis services provider accessible by users such as advertisers through a network connection, such as the internet, it should be understood that the advertising analysis tool may also be implemented on a user's computer. Accordingly, the system may be a desktop application that resides on the computer operated by the user, such that the user computer is a part of the advertising analysis system. Furthermore, the system may be a stand-alone application, or it may be integrated into another system and/or software program. For instance, the advertising analysis system may be integrated with one or more other online services solutions of an advertising or financial services provider which has various other online services, such as providing advertising information, advertising pricing and estimates, client account information, and the like.

The method 100 comprises step 102 in which the advertising analysis system receives advertising parameters for an advertising campaign. For example, as described above, the advertising parameters may include the selected time period for the advertising campaign, the desired budget for the entire campaign or per advertisement, the target demographics for the advertising campaign, selected sites for advertising campaign, number of advertisements for the advertisement campaign, and a target level of viewership. The advertising parameters may be provided by a user, such as an advertiser or an advertising agency, or from another computerized system, such as an advertising campaign program or system, or other by some other suitable means. In one embodiment, as described in more detail below, the advertising analysis system may be accessible through a website on the internet. In such case, the user may input the advertising parameters through the website, and the advertising analysis system may receive the parameters through the internet.

At step 104, the advertising analysis system accesses past event data regarding a plurality of past events. The past event data typically includes data regarding a wide range of events, such as television shows, live shows such as concerts, plays and theatre, sporting events, celebrity events, online events, and any other event that may have a large viewership. The data for each event may include the event time period, the type of event, the participants or performers, the location or outlet, and the attendance or viewership. The advertising analysis system may access the past event data through various available APIs having large databases of such data regarding past events, such as CitySearch™, Ticketmaster™, TVAnytime™ and the like. As described below, the advertising analysis system may access the APIs through a communication network, such as the internet and/or a private network.

The advertising analysis system may store the past event data in a database that can be accessed by the advertising analysis system. Accordingly, step 104 may include accessing the past event data from a database in operable communication with the advertising analysis system. The advertising analysis system may analyze and organize the accessed past event data in the database.

At step 106, the advertising analysis system accesses viewership data regarding media viewership, especially during the past event time periods of the past events. The viewership data includes data regarding the actual viewership of numerous media outlets, including numbers of viewers, hits or traffic, the time period of the viewership, and the demographics of the viewership, if available. For instance, the viewership data for a television station may include the number of viewers at a particular time period, and the age and gender makeup of the viewership. For a website, the viewership data may include the number of hits or traffic to a particular website during a particular time period. The advertising analysis system accesses the viewership data from one or more available APIs or other viewership and ratings databases, such as the Nielsen ratings for television, and Quantcast™ and other website metrics APIs for websites.

As with the past event data, the advertising analysis system may store the viewership data in a database that can be accessed by the advertising analysis system. As with step 102, step 104 may include accessing the viewership data from a database in operable communication with the advertising analysis system. The advertising analysis system may analyze and organize the viewership data in the database.

At step 108, the advertising analysis system correlates the past event data to the viewership data in order to make an association between a past event and the viewership of a particular media outlet. In this step, the advertising analysis system utilizes one or more algorithms to determine whether there is a correlation between a past event and the viewership of a particular media outlet. For instance, the system is looking for past events that likely had an effect on the viewership of a particular media outlet. The effect may be a decrease in viewership, i.e. a disruptive effect on the viewership, or an increase in the viewership, i.e. an augmenting effect on the viewership. In order to find a correlation between a past event and viewership data, the system may search for the same type of events or analogous events which occurred at the same venue, but at different time periods, to determine if the viewership data showed a similar change at the time of each event. As an example, the past event data may specify a professional football game occurring each Sunday at a city's stadium at a particular time. The system may analyze the football games and correlate the football games with viewership data of media within the vicinity of the football game, during and around the time of the football game, because the football game and the media viewership are in the same geographical area and occurring at about the same time. The system can correlate the geographic and time relationship to associate the past event data to the particular viewership data.

Step 108 involves making such correlations for numerous events and numerous media outlets, including various television stations and websites. The system may store the correlations in a database from which to access the correlation data, and to continue to analyze, update and store the correlation data as new past event data and viewership data is accessed by the system. In this way, the system can further validate the correlations and also determine new correlations.

At step 110, the advertising analysis system determines whether the past events correlated with viewership data had an effect on media viewership. It is possible that past events that are correlated at step 108 (e.g. in time and location) may not have any effect on media viewership, for various reasons. On the other hand, past events that are correlated at step 108 with media viewership may have an effect on media viewership. For example, the advertising analysis system may determine whether the correlated past events had a significant effect on media viewership. This determination may also take into account many other factors, such as a statistical analysis and/or extrapolation of data related to other similar events and viewership data to determine whether a past event effected media viewership. This step may also involve determining, or estimating, a past effect on media viewership based on the step of correlating past events to the viewership data. Continuing the football game example above, the viewership data may indicate a drop in viewership on the city's ABC affiliate during each of these football games. The system would then determine that the football games caused a drop in viewership on the ABC affiliate.

Similar to step 108, step 110 involves making such determinations for numerous past events and numerous media outlets, including various television stations and websites. The system may store the determinations in a database in which the system can access the data of determined effects of past events on viewership data, and to continue to analyze, update and store the past effects data as new past event data and viewership data is accessed by the system. Accordingly, the system can continuously update the past effects data.

At step 112, the advertising analysis system accesses future event data regarding events scheduled during, or near, the selected time period for the advertising campaign. The advertising analysis system may access the future event data using one or more available APIs having future event data, such as APIs available from CitySearch, Ticketmaster, TVAnytime, cbs.com, espn.com, and other websites of interest, among others. The future event data may include any or all of the following, for each future event: the scheduled time period, the location and venue, the website, the type of event, etc. The advertising analysis system may analyze the future event data to determine various parameters of the event, such as the type of event based on its description in the future event data, the duration of the event, expected attendance and/or viewership, as well as other parameters.

At step 114, the advertising analysis system identifies the future event(s) that are likely to have an effect on the advertising campaign by analyzing and comparing the determined past events having an effect on viewership and the future events that are during, or around, the time of the selected time period for the advertising campaign. Carrying on the football game example, the system may determine that there is another football game schedule for the selected time period for the advertising campaign. The system would then identify the future football game as potentially having a similar effect on the viewership of the ABC affiliate during the selected time period of the advertising campaign. The system may also identify other events that may have a disruptive effect, or an augmenting effect on the advertising campaign.

The identified future events can then be provided by the system to the advertiser so that the advertiser can evaluate the advertising campaign. As discussed above, it is currently an arduous, and mostly manual, task to perform the exhaustive searches to identify and understand the future events that may potentially conflict with an advertising campaign. Thus, the method 100 provides an automated process for identifying the future events that are likely to have an effect on the advertising campaign. The advertiser may use the information to reschedule the advertising campaign, or to negotiate the pricing of the advertising campaign with the publisher of the advertising campaign. The advertiser may reschedule the selected time period for the advertising campaign and re-run the method 100 using the revised selected time period. In addition, the advertiser can input revised advertising parameters based on the identified future events, and the advertising analysis system can identify time periods and media outlets for the advertising campaign that best meet the specified advertising parameters. The advertising analysis system may also be configured to also provide a recommendation to proceed or not to proceed with the advertising campaign as specified. For example, if the system determines that there only very minor future events having an effect on the advertising campaign, the system may recommend proceeding with the advertising campaign. On the other hand, if the system determines that there are major future events, or many future events, having an effect on the advertising campaign, the system may recommend NOT to proceed with the advertising campaign.

It should be understood that the steps of method 100 are not required to be performed in the order shown in FIG. 1, or as described above, but can be performed in any order that accomplishes the intended purpose of the method 100. For example, step 102 could be performed after steps 104 through 110. Similarly, step 106 could be performed after step 104.

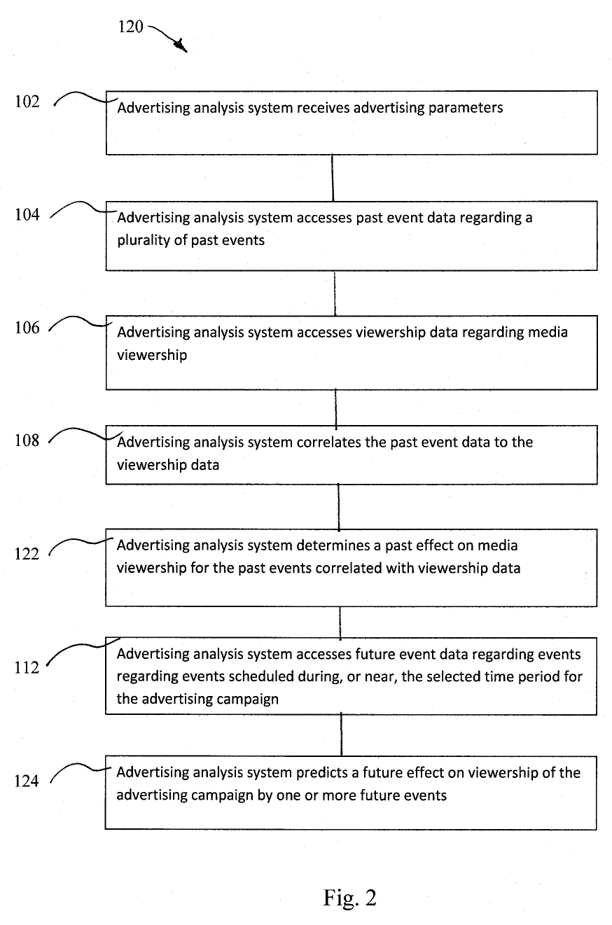

Turning to FIG. 2, another embodiment of an advertising analysis tool according to the present invention is method 120 for predicting an effect of an event on an advertising campaign. Method 120 includes the same steps 102, 104, 106, 108 and 112 described above for method 100, and the description above applies equally for method 120. Also, method 120 may be performed on the advertising analysis system substantially the same as the one described above for method 100, with straight-forward configuration modifications to perform method 120. Method 120 differs from method 100 in that it predicts an actual magnitude of an effect of a future event on the advertising campaign, rather than simply identifying potentially disruptive or augmenting future events.

Accordingly, at step 122 of method 120, the advertising analysis system determines a past effect on media viewership for the past events correlated with viewership data at step 108. This determination is an estimation which also may take into account many other factors, such as a statistical analysis, averages of multiple past events, and/or extrapolation of data related to other similar events and viewership data to determine the past effect of a past event on media viewership. For instance, in the football example above, the past effect on media viewership may be an average of the measured effect of each football game on the viewership of the ABC affiliate for several of the football games, or the football games for past years on the same or nearby day of the year. The past effect determined by the system may be a percentage change in media viewership for a media outlet, a change in the magnitude of the viewership (such as a decrease or increase of 100,000 viewers), or other suitable measure of the past effect.

At step 124 of method 120, the advertising analysis system predicts the effect (called a future effect) on viewership of the advertising campaign by one or more future events. Similar to the determination of a past effect at step 122, the prediction of a future effect predicts a magnitude or range of magnitude of the effect on viewership. Typically, the future events having a future effect on the viewership of the advertising campaign will be future events scheduled near the selected time period for the advertising campaign. As used herein, the term “near” with respect to time periods means at, during, and/or around the same time period. The system analyzes the past effects determined at step 122, the future events, the selected media outlets selected as part of the advertising parameters, and then compares, analogizes and contrasts the information make a prediction, or estimate, of the future effect of the future events on viewership of the advertising campaign. The future effect may be predicted in terms of a percentage change in media viewership for a media outlet, a change in the magnitude of the viewership (such as a decrease or increase of 100,000 viewers), or other suitable measure of the future effect.

An advertiser can use the prediction of the method 120 similar to the information provided by method 100, but with even more detailed and specific information. Thus, the advertiser can evaluate whether the predicted future effect causes an excessive decrease in viewership and if so, the advertiser may reschedule the advertising campaign, or negotiate lower pricing with the publisher of the advertising campaign. As with method 100, the advertiser may reschedule the selected time period for the advertising campaign and re-run the method 120 using the revised selected time period, or the advertiser can input revised advertising parameters based on the predicted future effects, and the advertising analysis system can identify time periods and media outlets for the advertising campaign that best meet the specified advertising parameters. The advertising analysis system may also be configured to provide a recommendation to proceed or not to proceed with the advertising campaign as specified. For example, if the system determines that the future effect decreases the viewership below a threshold, such as a minimum cost of advertising per viewer in the target demographic, the system may recommend NOT to proceed with the advertising campaign. On the other hand, if the system determines that the future effects do not decrease the viewership below a threshold, the system may recommend proceeding with the advertising campaign. The threshold for the system recommendation may be the average cost to advertise to the target demographic during the selected time period, or some other score assigned by the system that is related to the ratio of “the cost of advertising for a particular time slot” to “the number of forecast viewers.” The number of forecast viewers is equal to the historic viewership statistics adjusted by the future effect predicted by the method 120. The historic viewership statistics may be accessed by the system similar to step 106 for accessing viewership data regarding media viewership, as described above.

As with method 100 above, it should be understood that the steps of method 120 are not required to be performed in the order shown in FIG. 2, or as described above, but can be performed in any order that accomplishes the intended purpose of the method 100. For example, step 102 could be performed after steps 104 through 110. Similarly, step 106 could be performed after step 104.

The following is a simplistic hypothetical example of the method 120, provided to illustrate the operation of the method of predicting a future effect on viewership of an advertising campaign. In this hypothetical example, a business wants to advertise a promotion for a particular date range and a particular demographic. The business provides, and the advertising analysis system receives at step 102, the following advertising campaign parameters:
a. Advertise a promotion from Aug. 6-Aug. 8, 2011 on local CBS affiliate.
b. Target Demographic: 18-35 year old males

At step 104, the system accesses past event data for a plurality of the past events. Within the past event data is the following information: in the past three years, 3 events, labeled event x, event y, and event z, occurred every year during August 6-August 8. As described above, these events and numbers are compiled using open APIs from event aggregator websites.

At step 106, the system accesses viewership data regarding media viewership including the following data: the CBS affiliate station had viewership of 600,000 viewers of the target demographic each year in the similar time slots as the proposed advertising campaign (i.e. August 6-8, at specific times of the day); the viewership decreased by 50,000 viewers each year at the time periods of event x, event y and event z. At step 108, the system correlates the past event data to the viewership data by determining that the events occurred at the same time as the past events, and were located geographically.

At step 122, the system determines that of the 600,000 viewers of the CBS affiliate average, 50,000 viewers/year switched over from the particular CBS affiliate station to watch event x, event y and event z. The 50,000 viewer number was calculated by compiling past viewership data that is also available through available APIs, as described above. It may be the average over the previous 3 years of data that is available through the APIs.

Because of this simple ratio (50,000/600,000), the system can now predict that if event x, event y, and event were to again occur in the future, and the business wanted to advertise on the same CBS affiliate station during this time period, approximately 8.3% (50k/600k) of the target audience will be lost to event x, event y, and event z.

At step 112, the system accesses future event data and determines that event x, event, y and event z are scheduled for August 6-8 again in 2011. Accordingly, at step 124 the system predicts that there will be a future effect on the advertising campaign caused by event x, event y and event z in the amount of an 8.3% drop in the target demographic (alternatively, the system may predict a drop of 50,000 viewers in the target demographic, depending on factors such as the type of events, e.g. do the events x, y and z have fixed capacities, or not).

The data obtained from the method described above can also be used to extrapolate a number of different scenarios involving any combination of the CBS affiliate station and events x, y, and z resulting in numerous different scenarios being produced for different advertisers. These numbers, of course, are subject to variance which can be deduced by utilizing simple statistical models which will result in a standard deviation for this particular scenario. Also, in order to minimize the amount of noise in the model, past data may be utilized en-masse. In other words, the more past data available to the model, the better average that can be calculated, which will result in a more accurate prediction, and hence a lower standard deviation.

The system may assign a score to the potential success of the hypothetical advertising campaign based on the results provided by the method 120. The score incorporates the ratio of “cost of advertising for a particular timeslot” to “the number of forecast viewers.” The number of forecast viewers is equal to historic viewer statistics+/−the output of the predictive tool (−8.3% in this case). Average advertising cost figures can be derived by random sampling of local and national television networks, or can be provided as part of the advertising parameters.

If the score for the advertising campaign falls below the threshold score which is computed as the average cost to advertise to the particular demographic during that time period, then the system will recommend NOT to advertise. If the score is equal to or above the threshold score, then the tool will recommend to advertise. By submitting numerous requests and receiving feedback on when to advertise, the advertiser can most effectively plan the advertising campaign.

In addition, in other aspects of the present invention, the advertiser can input revised advertising parameters based on the identified future events, and the advertising analysis system can identify time periods and media outlets for the advertising campaign that best meet the specified advertising parameters. For example, if the advertiser inputs advertising parameters specifying a certain demographic and target viewership (e.g. number of viewers or hits), the advertising analysis system can analyze the parameters based on the correlating and determining steps, and the database of viewership data, past event data and future event data, to recommend time period(s) and media outlets best meeting the specified advertising parameters.

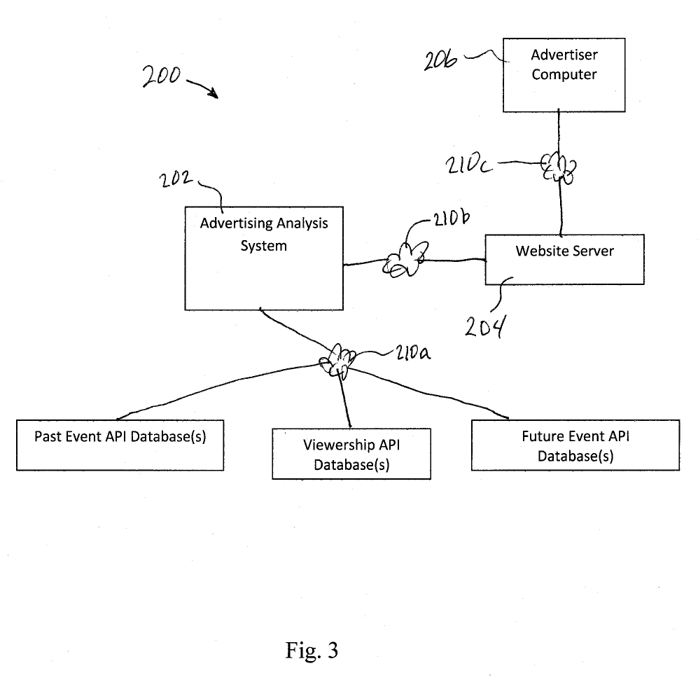

Referring now to FIG. 3, a non-limiting example of a system 200 that may be used to implement any of the methods 100 and 120 as shown in FIGS. 1 and 2, as well as other method embodiments that may be described herein, is depicted. It should be understood that not all of the components of the system 200 are needed to implement the methods 100 and 120, and therefore, the system may include only those components necessary to perform the method embodiments as described herein.

The system 200 includes an advertising analysis system 202 which comprises one or more computers, and/or computer servers, hosting an advertising analysis software program. The software application is configured to perform the steps of the methods as described above, such as receiving advertising campaign parameters, accessing past event data regarding a plurality of past events, accessing viewership data regarding media viewership, correlating the past events to the viewership data, determining a past effect on media viewership based on said step of correlating said past events to said viewership data, predicting a future effect on viewership of the advertising campaign by future events.

The software may also be configured to access certain data using APIs, as described above. The advertising analysis system 202 is in communication with the API databases, a past event API database, a viewership API database, and a future event API database, through a communication network 210a. Through the communication network 210a, the advertising analysis system 202 can access the past event data, viewership data and future event data via the respective APIs.

The advertising analysis system 202 is also in communication with a website server 204 through a communication network 210b. The website server 204 may comprises one or more computers, servers and peripherals in operable communication with each other in which at least one of the servers is connected to the internet, such as through communication network 210c. The website server is further programmed to facilitate communication between the system 200 and an advertiser computer 206 through the communication network 210c. Accordingly, the website server 204 includes pages, files and programming to interact with the advertiser computer 206 to accomplish the advertising analysis methods as described herein. Alternatively, the advertising analysis system 202 and website server 204 may be integrated together.

Each of the networks 210a and 210b may include a proprietary network, LAN, WAN, cellular network, wireless network, the internet, and/or other suitable network, or any combination thereof.

Accordingly, system 200 is provided which can implement the advertising analysis methods according to the methods 100 and 120, and any other methods described herein.

The methods 100 and 120, as well as any other method embodiments described herein, may also be embodied in, or readable from, a computer-readable medium (computer program carrier), e.g., one or more of the fixed and/or removable data storage data devices and/or data communications devices connected to a computer. The computer program carrier is readable by a computer and embodies instructions executable by the computer to perform the method steps of programming a computer to perform the methods 100 and 120, or any other method embodiments described herein. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, and DVD-RW.

Although particular embodiments have been shown and described, it is to be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. Accordingly, embodiments are intended to exemplify alternatives, modifications, and equivalents that may fall within the scope of the claims.

What is claimed is:

1. A method of evaluating an advertising campaign scheduled for a selected time period, comprising the following steps:
accessing, by an advertising analysis system, past event data regarding a plurality of past events occurring during respective past event time periods;
accessing, by said advertising analysis system, viewership data regarding media viewership during the past event time periods of said past events;
correlating, by said advertising analysis system, said past events to said viewership data;
determining, by said advertising analysis system, that a past event caused a significant past effect on media viewership based on said step of correlating said past events to said viewership data; and
identifying, by said advertising analysis system, one or more future events that are likely to have a future effect on viewership of said advertising campaign, based at least in part upon the step of determining.

2. The method of claim 1, further comprising the step of:
accessing, by said advertising analysis system, future event data regarding said future events.

3. The method of claim 1, wherein said step of accessing viewership data regarding media viewership during the time periods of said past events is performed using a first application programming interface, and said step of accessing past event data is performed using a second application interface.

4. The method of claim 3, further comprising the step of:
accessing, by said advertising analysis system, data regarding said future events using a third application programming interface.

5. The method of claim 1, further comprising the step of:
providing, by said advertising analysis system, a recommendation to an advertiser regarding the advertising campaign based on said step of identifying one or more future events.

6. The method of claim 1, wherein said step of correlating said past events to said viewership data includes a statistical analysis of the past event data and viewership data and extrapolation of such data.

7. The method of claim 1, further comprising the step of:
receiving, by said advertising analysis system, advertising parameters for said advertising campaign, from an advertiser through a communication network.

8. A method of evaluating an advertising campaign scheduled for a selected time period, comprising the following steps:
accessing, by an advertising analysis system, past event data regarding a plurality of past events occurring during respective past event time periods;
accessing, by said advertising analysis system, viewership data regarding media viewership during the past event time periods of said past events;
correlating, by said advertising analysis system, said past events to said viewership data;
determining, by said advertising analysis system, a past effect on media viewership based on said step of correlating said past events to said viewership data; and
predicting, by said advertising analysis system, a future effect on viewership of said advertising campaign by future events scheduled for said scheduled time period based, at least in part, upon said determined past effect.

9. The method of claim 8, further comprising the step of:
accessing, by said advertising analysis system, future event data regarding said future events.

10. The method of claim 8, wherein said step of accessing viewership data regarding media viewership during the time periods of said past events is performed using a first application programming interface, and said step of accessing past event data is performed using a second application interface.

11. The method of claim 10, further comprising the step of:
accessing, by said advertising analysis system, data regarding said future events using a third application programming interface.

12. The method of claim 1, further comprising the step of:
providing, by said advertising analysis system, a recommendation to an advertiser regarding the advertising campaign based on said step of predicting a future effect on viewership of said advertising campaign by future events.

13. The method of claim 1, wherein said step of correlating said past events to said viewership data includes a statistical analysis of the past event data and viewership data and extrapolation of such data.

14. The method of claim 1, further comprising the step of:
receiving, by said advertising analysis system, advertising parameters for said advertising campaign, from an advertiser through a communication network.

15. A system for evaluating an evaluating an advertising campaign scheduled for a selected time period, the system comprising:
an advertising analysis system comprising at least one computer, the advertising analysis system connected to a communication network which is in communication with a past event database accessible through a first application programming interface, a viewership database accessible through a second application programming interface and a future event database accessible through a third application programming interface, the advertising analysis system also in communication with an advertiser computer, the advertising analysis system configured to perform the following steps:
accessing past event data regarding a plurality of past events occurring during respective past event time periods;
accessing viewership data regarding media viewership during the past event time periods of said past events;
correlating said past events to said viewership data;
determining that a past event caused a significant past effect on media viewership based on said step of correlating said past events to said viewership data; and
identifying one or more future events that are likely to have a future effect on viewership of said advertising campaign, based at least in part upon the step of determining.

16. A system for evaluating an evaluating an advertising campaign scheduled for a selected time period, the system comprising:
an advertising analysis system comprising at least one computer, the advertising analysis system connected to a communication network which is in communication with a past event database accessible through a first application programming interface, a viewership database accessible through a second application programming interface and a future event database accessible through a third application programming interface, the advertising analysis system also in communication with an advertiser computer, the advertising analysis system configured to perform the following steps:
accessing past event data regarding a plurality of past events occurring during respective past event time periods;
accessing viewership data regarding media viewership during the past event time periods of said past events;
correlating said past events to said viewership data;
determining a past effect on media viewership based on said step of correlating said past events to said viewership data; and
predicting a future effect on viewership of said advertising campaign by future events scheduled for said scheduled time period based, at least in part, upon said determined past effect.

17. An article of manufacture comprising a computer program carrier readable by a computer and embodying instructions executable by the computer to program a computer to perform the following steps for evaluating an advertising campaign scheduled for a selected time period:
accessing past event data regarding a plurality of past events occurring during respective past event time periods;
accessing viewership data regarding media viewership during the past event time periods of said past events;
correlating said past events to said viewership data;
determining that a past event caused a significant past effect on media viewership based on said step of correlating said past events to said viewership data; and
identifying one or more future events that are likely to have a future effect on viewership of said advertising campaign, based at least in part upon the step of determining.

18. An article of manufacture comprising a computer program carrier readable by a computer and embodying instructions executable by the computer to program a computer to perform the following steps for evaluating an advertising campaign scheduled for a selected time period:
accessing past event data regarding a plurality of past events occurring during respective past event time periods;
accessing viewership data regarding media viewership during the past event time periods of said past events;
correlating said past events to said viewership data;
determining a past effect on media viewership based on said step of correlating said past events to said viewership data; and
predicting a future effect on viewership of said advertising campaign by future events scheduled for said scheduled time period based, at least in part, upon said determined past effect.
